(19) United States
(12) Patent Application Publication
(10) Pub. No.: US 2025/0180878 A1
(43) Pub. Date: Jun. 5, 2025

(54) IMAGING LENS ASSEMBLY, CAMERA MODULE AND IMAGING DEVICE

(71) Applicant: GUANGDONG OPPO MOBILE TELECOMMUNICATIONS CORP., LTD., Dongguan (CN)

(72) Inventor: Tatsuya NAKATSUJI, Yokohama (JP)

(73) Assignee: GUANGDONG OPPO MOBILE TELECOMMUNICATIONS CORP., LTD., Dongguan (CN)

(21) Appl. No.: 19/053,196

(22) Filed: Feb. 13, 2025

Related U.S. Application Data
(63) Continuation of application No. PCT/CN2022/119260, filed on Sep. 16, 2022.

(51) Int. Cl. G02B 13/00; G02B 7/02; G02B 9/62; G02B 27/64

(52) U.S. Cl. CPC G02B 13/0065; G02B 7/021; G02B 9/62; G02B 13/0045; G02B 27/646

(57) ABSTRACT

An imaging lens assembly includes an optical member, a lens group, and a light-shielding member. The optical member is configured to bend an incident light incident from an object side toward an image side. The lens group is disposed on the image side of the optical member and configured to image the incident light bent by the optical member on an imaging surface. The light-shielding member partially shields the incident light. The light-shielding member includes a light-shielding mask and an aperture stop. The light-shielding member is provided with a first aperture partially transmitting the incident light. The aperture stop partially shields the incident light on the image side of the optical member and is provided with a second aperture partially transmitting the incident light. The imaging lens assembly is configured such that tan(DFOV)>0.59, dm≥da.

### CROSS-REFERENCE TO RELATED APPLICATIONS

The present application is a continuation of International Patent Application No. PCT/CN2022/119260, filed Sep. 16, 2022, which is herein incorporated by reference in its entirety.

### TECHNICAL FIELD

The present disclosure relates to an imaging lens assembly, a camera module, and an imaging device, and more specifically, to an imaging lens assembly, a camera module, and an imaging device that are thin and enable favorable optical performance.

### BACKGROUND

Conventionally, portable imaging devices such as mobile phones and digital cameras are being widely used. Such devises are required to be thin enough to be carried around. In order to make the imaging devices thin (reduction in height), a periscope-type imaging lens assembly is disposed a prism on an object side of its lens group.

However, conventional periscope-type imaging lens assemblies have been almost always applied to telephoto lenses. Therefore, when a conventional periscope-type imaging lens assembly is applied to a wide-angle lens, an amount of peripheral light is significantly decreased.

Therefore, periscope-type imaging lens assemblies have not been suitable for use in wide-angle lenses.

### SUMMARY

In accordance with the present disclosure, an imaging lens assembly includes:
an optical member configured to bend an incident light incident from an object side toward an image side;
a lens group disposed on the image side of the optical member to image the incident light bent by the optical member on an imaging surface; and
a light-shielding member partially shielding the incident light, the light-shielding member including:
a light-shielding mask partially shielding the incident light on the object side of the optical member and being provided with a first aperture partially transmitting the incident light; and
an aperture stop partially shielding the incident light on the image side of the optical member and being provided with a second aperture partially transmitting the incident light,
the imaging lens assembly configured such that:

tan(DFOV/2)>0.59,

dm≥da,
wherein DFOV is a diagonal angle of view of the imaging lens assembly, dm is a size of the first aperture of the light shielding mask in a first direction optically corresponding to a shorter direction of the imaging surface, and da is a size of the second aperture of the aperture stop in a second direction optically corresponding to the shorter direction of the imaging surface.

In accordance with the present disclosure, a camera module includes:
the imaging lens assembly; and
an image sensor including the imaging surface.

In accordance with the present disclosure, an imaging device includes:
the camera module; and
a drive mechanism integrally driving the lens group along an optical axis.

### BRIEF DESCRIPTION OF THE DRAWINGS

These and/or other aspects and advantages of embodiments of the present disclosure will become apparent and more readily appreciated from the following descriptions made with reference to the drawings.

FIG. 1 is a schematic diagram of an imaging device according to the present disclosure.

FIG. 2 is a perspective view illustrating an optical member and a light-shielding member of the imaging device according to the present disclosure.

FIG. 3 is a plane view of a light-shielding mask for explaining lens parameters of an imaging lens assembly according to the present disclosure.

FIG. 4 is a plane view of an imaging surface for explaining the lens parameters of the imaging lens assembly according to the present disclosure.

FIG. 5A is an explanatory schematic diagram for explaining the lens parameters of the imaging lens assembly according to the present disclosure.

FIG. 5B is another explanatory schematic diagram for explaining the lens parameters of the imaging lens assembly according to the present disclosure.

FIG. 6A is an explanatory schematic diagram different from FIG. 5A for explaining the lens parameters of the imaging lens assembly according to the present disclosure.

FIG. 6B is an explanatory schematic diagram different from FIG. 5B for explaining the lens parameters of the imaging lens assembly according to the present disclosure.

FIG. 7 is a YZ cross-sectional view of a camera module according to a first example of the present disclosure.

FIG. 8 is a XZ cross-sectional view of the camera module according to the first example of the present disclosure.

FIG. 9 is a schematic diagram illustrating a light path of the imaging lens assembly in a state where a prism is not disposed, in the imaging lens assembly according to the first example of the present disclosure.

FIG. 10 is an aberration schematic diagram of a camera module according to the first example of the present disclosure.

FIG. 11 is a YZ cross-sectional view of a camera module according to a second example of the present disclosure.

FIG. 12 is a XZ cross-sectional view of the camera module according to the second example of the present disclosure.

FIG. 13 is a schematic diagram illustrating a light path of the imaging lens assembly in a state where a prism is not disposed, in the imaging lens assembly according to the second example of the present disclosure.

FIG. 14 is an aberration schematic diagram of a camera module according to the second example of the present disclosure.

FIG. 15 is a YZ cross-sectional view of a camera module according to a third example of the present disclosure.

FIG. 16 is a XZ cross-sectional view of the camera module according to the third example of the present disclosure.

FIG. 17 is a schematic diagram illustrating a light path of the imaging lens assembly in a state where a prism is not disposed, in the imaging lens assembly according to the third example of the present disclosure.

FIG. 18 is an aberration schematic diagram of a camera module according to the third example of the present disclosure.

### DETAILED DESCRIPTION

Embodiments of the present disclosure will be described in detail and examples of the embodiments will be illustrated in the accompanying drawings. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

The present disclosure aims to solve at least one of the technical problems mentioned above. Accordingly, the present disclosure needs to provide an imaging lens, a camera module and an imaging device.

### Outline of the Disclosure

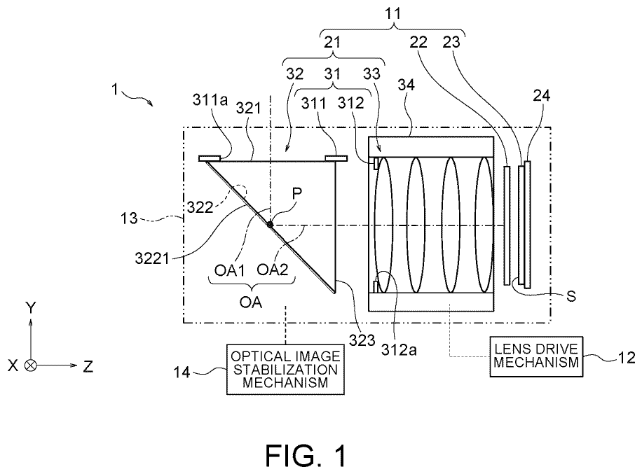

First, an outline of the present disclosure will be described. An imaging device 1 to which the present disclosure is applied is, for example, configured as shown in FIG. 1. Note that the dash-dotted line denotes an optical axis OA of the imaging device 1 (hereinafter the same applies). Also, in the Figures, a direction along the optical axis OA of a lens group is defined as a Z-axis, a direction of thickness (i.e., direction of height) of the imaging device 1 as a Y-axis, and a direction perpendicular to the Z-axis and the Y-axis as an X-axis.

As shown in FIG. 1, the imaging device 1 shown in FIG. 1 includes a camera module 11, a lens drive mechanism 12, and a housing 13 which stores the camera module 11 and the lens drive mechanism 12. The camera module 11 includes an imaging lens assembly 21, an optical filter 22, and an image sensor 23 having an imaging surface S. The imaging lens assembly 21 includes a light-shielding member 31, an optical member 32, and a lens group 33. The light-shielding member 31 includes a light-shielding mask 311 and an aperture stop 312.

In addition, the imaging device 1, as a technique for performing optical image stabilization (OIS) when shooting, may have an optical image stabilization mechanism 14 which drives the optical member 32, the lens group 33, and the image sensor 23. The optical image stabilization mechanism 14, for example, is an actuator having a function of rotating the optical member 32 in the X-axis, a function of moving the lens group 33 in an XY direction, and a function of moving the image sensor 23 in the XY direction. This actuator, for example, based on a detection result of a position sensor or a gyro sensor which detects a direction and amount of a camera shake, may move the lens group 33 and the image sensor 23 in the direction and amount which resolve the detected camera shake.

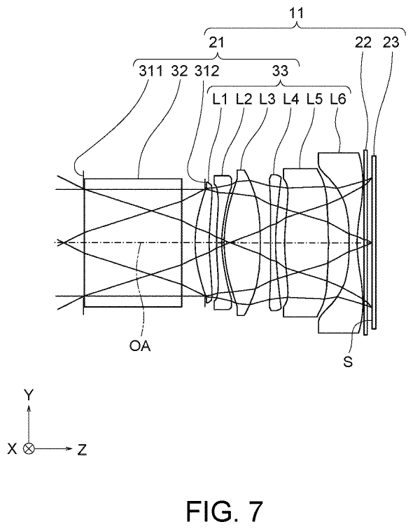

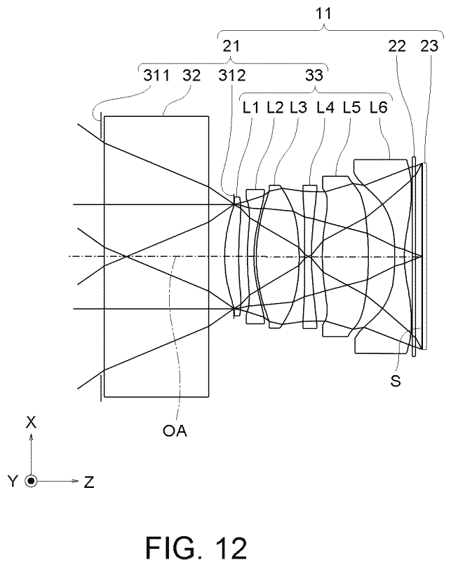

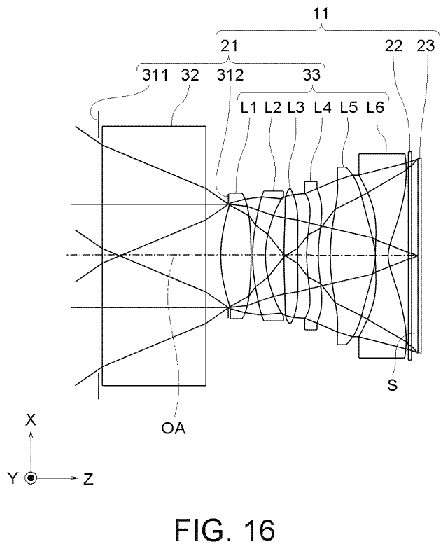

The camera module 11, to which the present disclosure is more specifically applied, is configured as shown in FIGS. 7, 8, 11, 12, 15, and 16, for example.

The optical member 32 is configured to bend an incident light incident from an object side toward an image side. In the example shown in FIG. 1, the optical member 32 is configured to bend the optical axis OA of the imaging lens assembly 21 towards the image side by substantially 90°. By bending the optical axis OA by substantially 90°, the imaging device 1 may be effectively made thin.

In specific, in the example shown in FIG. 1, the optical axis OA of the imaging lens assembly 21 includes a first optical axis OA1 on the object side and a second optical axis OA2 on the image side. The first optical axis OA1 is substantially parallel to the Y-axis. The second optical axis OA2 is substantially parallel to the Z-axis. The second optical axis OA2 is connected to the first optical axis OA1 to be substantially perpendicular at a connection point P on the optical member 32. The first optical axis OA1 is substantially parallel to the shorter direction of the imaging surface S. The second optical axis OA2 is an optical axis common to the optical axis of the lens group 33. Through designing the optical axis OA as such, the optical member 32, the lens group 33, and the image sensor 23 may be arranged straightly in a direction (Z-axis) perpendicular to the direction of thickness (Y-axis) of the imaging device 1. As such, the imaging device 1 may be effectively made thinner.

More specifically, the optical member 32 includes an incident surface 321, a reflective surface 322, and an emitting surface 323. Light incidents toward the incident surface 321 from the object side. The reflective surface 322 includes the connection point P of the first optical axis OA1 and the second optical axis OA2. The reflective surface 322 reflects the light incident from the incident surface 321 toward the image side. In an example shown in FIG. 1, the reflective surface 322, coated with a multilayer thin film 3221 having reflective characteristics, reflects incident light from the incident surface 321 side toward the image side. The reflective surface 322 is not limited to being coated with the multilayer thin film 3221, but, for example, may totally reflect the light from the incident surface 321, internally incident at an incident angle greater than a critical angle, toward the image side. The emitting surface 323 emits the light reflected at the reflective surface 322 toward the object side. The incident surface 321 is substantially perpendicular to the first optical axis OA1 and the imaging surface S. The reflective surface 322 is substantially inclined 45° against the incident surface 321. By being inclined 45° against the incident surface 321, the reflective surface 322 may make the first optical axis OA1 and the second optical axis OA2 substantially perpendicular. The emitting surface 323 is substantially perpendicular to the incident surface 321 and is substantially parallel to the imaging surface S. With the optical member 32 having a configuration as above, the optical axis OA may be bent by substantially 90° with a simple configuration. The optical member 32 may be preferably realized by a prism.

The light-shielding member 31 is a member that partially shields incident light from the object side. The light-shielding member 31 consists of just a light-shielding mask 311 and an aperture stop 312. That is to say, in the imaging lens assembly 21, other than unintended light absorption or dispersion on an optical surface, optical elements that may intentionally control a radiation intensity of a central luminous flux of incident light is just the light-shielding mask 311 and the aperture stop 312.

A light-shielding mask which cuts the luminous flux around a screen other than the central luminous flux may be inserted inside the lens group 33 depending on an arbitrary peripheral light which is necessary. It is desirable for the imaging lens assembly 21 to have just the light-shielding mask 311 and the aperture stop 312 as light-shielding means in order to achieve a lens with bright peripheral light.

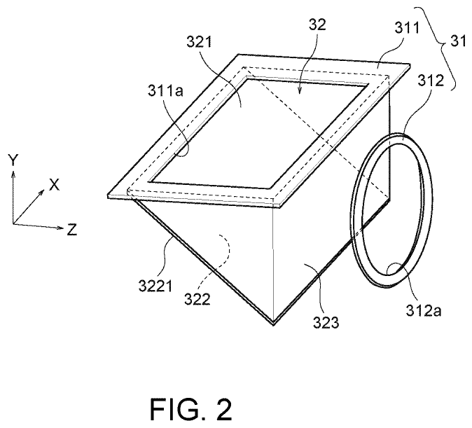

The light-shielding mask 311 partially shields the incident light on the object side (i.e., incident side) of the optical member 32. The light-shielding mask 311 is disposed on the object side of the optical member 32. In specific, the light-shielding mask 311 is disposed on the incident surface 321 of the optical member 32. As shown in FIG. 2, a first aperture 311a which partially transmits the incident light is provided in the light-shielding mask 311. The first aperture 311a may be shaped as a rectangle or as other shapes. For example, the first aperture 311a may be shaped as a rounded rectangle consisting of parallel lines with two equivalent lengths and two half-circles. A center of the first aperture 311a may be located on the first optical axis OA1.

The first aperture 311a of the optical mask 311 has a longer direction along a longer direction of the imaging surface S. For example, when the first aperture 311a is shaped as the rectangle or the rounded rectangle, a long side of the first aperture 311a is parallel to a long side of the imaging surface S. Likewise, the first aperture 311a of the light-shielding mask 311 has the shorter direction substantially perpendicular to the shorter direction of the imaging surface S. The shorter direction of the first aperture 311a is substantially parallel to the second optical axis OA2. The longer direction of the first aperture 311a is substantially perpendicular to the second optical axis OA2. According to such structure of the light-shielding mask 311, since the light-shielding mask 311 may effectively shield incident light on the shorter direction of the first aperture 311a, which is optically corresponding to the shorter direction of the imaging surface S, the radiation intensity of imaging rays on the shorter direction of the imaging surface S may be effectively limited. Accordingly, the height of the optical member 32 and the imaging surface S may be reduced, and thus the imaging device 1 may be made thin more effectively. Also, since the incident light may be shielded less in the longer direction of the first aperture 311a compared to the shorter direction of the first aperture 311a, the peripheral light may be effectively sustained. It is also possible to modify a length of the longer direction of the first aperture 311a by arbitrarily matching to the peripheral light which is necessary.

The aperture stop 312 partially shields the incident light on the image side (i.e., emitting side) of the optical member 32. The aperture stop 312 is disposed on the image side of the optical member 32. As shown in FIG. 2, the aperture stop 312 is provided with a circular second aperture 312a which partially transmits the incident light. As shown in FIG. 1, the center of the second aperture 312a is located on the second optical axis OA2.

More specifically, the aperture stop 312 is disposed closer to the object side than a surface on the image side of the lens disposed closest to an object (i.e., optical member 32) among the lens group 33. By disposing the aperture stop 312 closer to the object side than the surface on the image side of the lens disposed closest to the object, incident angles of rays entering the imaging surface S may be mitigated. As such, the amount of the peripheral light may be sustained more effectively. To make the imaging device 1 thinner in the Y-axis, an upper end and a lower end of the aperture stop 312 may be cut and a dimension of the of the aperture stop 312 in the Y-axis may be made shorter than the diameter da of the second aperture 312a.

The lens group 33 is disposed on the image side of the optical member 32. The lens group 33 at least includes a lens disposed closest to the object and a lens disposed closest to the image (i.e., imaging surface S). The number of lenses to be included in the lens group 33, for example, may be 4 or more and 7 or less. By having 4 to 7 lenses included in the lens group 33, a favorable optical performance may be achieved without increasing a weight (i.e., energy to drive the lens group 33) of the lens group. Among the lens group 33, the lens disposed closest to the image may have a negative refractive power in paraxial region and a plurality of inflection points. By disposing the lens closest to the image having the negative refractive power and the plurality of inflection points, aberrations may be favorably corrected while shortening the entire length of the lens group 33

For a focus operation, the lens group 33 is configured to move integrally along the second optical axis OA2. Specifically, in the example shown in FIG. 1, the lens group 33 is held, i.e., fixed inside a single barrel 34. Accordingly, a relative positional relationship between the lenses in the lens group 33 does not change. Also, the lens group 33 is movable via the lens drive mechanism 12. The lens drive mechanism 12, for example, includes an actuator such as a stepping motor or a voice coil motor. The image sensor 23 is, for example, a solid-state image sensor such as CMOS (Complementary Metal Oxide Semiconductor) or CCD (Charge Coupled Device). The image sensor 23 has the imaging surface S which is the imaging surface of the imaging lens 21. The image sensor 23 is mounted on a board 24. The image sensor 23 receives incident light from a subject (object side) via the imaging lens assembly 21 and the optical filter 22, photoelectrically converts the light, and outputs an image data obtained by photoelectric conversion of the light, to a subsequent stage. The optical filter 22 may be, for example, an IR filter which cuts infrared light from light which is incident from the imaging lens assembly 21.

As described above, the imaging lens assembly 21 to which the present disclosure is applied is a periscope type imaging lens assembly 21 in which the optical member 32 is disposed on the object side of the lens group 33. Since a direction of the entire length of the lens group 33 is perpendicular to a direction of thickness of the imaging device 1, the overall length of the periscope type imaging lens assembly 21 does not adversely affect the thickness of the imaging device 1. Accordingly, the thickness of the imaging device 1 may be made thin. Further, the imaging lens assembly 21 to which the present disclosure is applied does not intentionally shield the incident light with optical elements other than the light-shielding mask 311 and the aperture stop 312. As such, sufficient peripheral light may be sustained even when a wide-angle lens is mounted. By sustaining sufficient peripheral light, noise may be reduced and a favorable image quality may be sustained.

Therefore, according to the imaging lens assembly 21, the imaging device 1 may be made thin while sustaining favorable optical performance.

The imaging lens assembly 21 to which the present disclosure is applied may more efficiently make the imaging device 1 thin and increase an angle of view by satisfying the following inequalities (1) and (2):

$$tan ( DFOV / 2 ) > 0.59 ; and \qquad ( 1 )$$

$$d m \geq da . \qquad ( 2 )$$

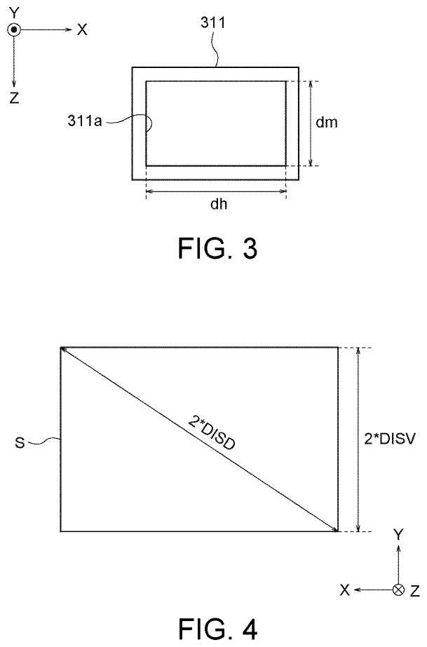

In the inequality (1), DFOV is a diagonal angle of view of the imaging lens assembly 21 (hereinafter the same applies). tan(DFOV/2) is a tangent of DFOV/2. In the inequality (2), dm is a size of the first aperture 311a of the light-shielding mask 311 in a first direction optically corresponding to the shorter direction of the imaging surface S (hereinafter the same applies). “The first direction optically corresponding to the shorter direction of the imaging surface S” means that, a size of the first aperture 311a in the first direction corresponds to (i.e. affects) the radiation intensity of imaging rays which is regulated in the shorter direction of the imaging surface S. As shown in FIG. 3, when the shape of the first aperture 311a is rectangular, dm is a size of the shorter direction of the first aperture 311a. da is a size of the second aperture 312a of the aperture stop in a second direction optically corresponding to the shorter direction of the imaging surface S (hereinafter the same applies). “The second direction optically corresponding to the shorter direction of the imaging surface S” means that, a size of the second aperture 312a in the second direction corresponds to the radiation intensity of imaging rays which is regulated in the shorter direction of the imaging surface S. As shown in FIG. 2, when the shape of the second aperture 312a is circular, da is a diameter of the second aperture 312a.

If tan(DFOV/2) falls below the lower limit of the inequality (1), it is difficult to increase the angle of view. If the value of dm falls below the lower limit of the inequality (2), since an effective F number increases, a brightness of an image is insufficient, and thus image quality decreases.

To make the imaging device 1 thin, dm is preferably equivalent to da (i.e., dm=da).

Further, the imaging lens assembly 21 may more effectively increase the angle of view by satisfying the following inequality (3):

$$BL < 4 mm . \qquad ( 3 )$$

In the inequality (3), BL is a distance on the optical axis OA from the surface on the image side of the lens disposed closest to the image among the lens group 33, to the imaging surface S. That is to say, BL is a back focus length of the imaging lens assembly 21 (hereinafter the same applies).

If BL exceeds the upper limit of the inequality (3), since a focal length is too large, it is difficult to increase the angle of view.

Further, the imaging lens assembly 21 may more effectively make the imaging device 1 thin by satisfying the following inequality (4). Also, when the imaging lens assembly 21 is applied to a mobile phone, it is possible to display a captured image effectively utilizing a display screen of the mobile phone.

$$DISV / DISD < 0.61 . \qquad ( 4 )$$

In the inequality (4), as shown in FIG. 4, DISD is half a size of the imaging surface S in a diagonal direction 2*DISD (hereinafter the same applies). That is to say, DISD is an image height. DISV is half a size of the imaging surface S in the shorter direction 2*DISV (hereinafter the same applies).

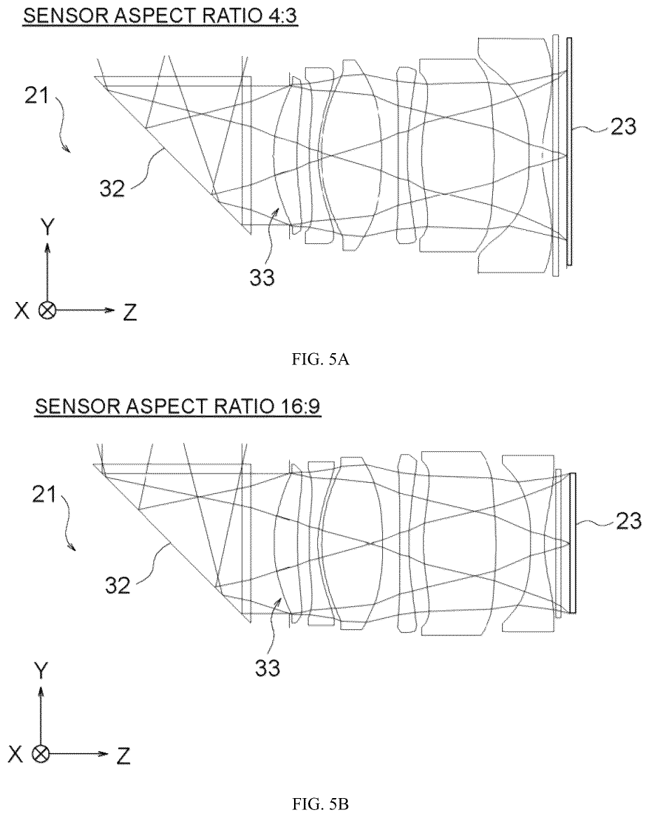

Here, FIG. 5A and FIG. 5B show the imaging lens assembly 21 where an aspect ratio (size of longer direction:size of shorter direction) of the image sensor 23 (i.e., imaging surface S) is 4:3, and the imaging lens assembly 21 where the aspect ratio is 16:9. As shown in FIG. 5A and FIG. 5B, the size of the image sensor 23 in the shorter direction, which affects the thickness of the imaging device 1, when the aspect ratio is 4:3 is different from the size of the image sensor 23 in the shorter direction when the aspect ratio is 16:9 even when the optical member 32 of the same size is used.

From FIG. 5A and FIG. 5B, it is clear that even when using optical members 32 of the same size, compared to when the aspect ratio is 16:9, the size of the image sensor 23 in the shorter direction (i.e., in the Y-axis) is greater when the aspect ratio is 4:3. Thus, compared to when the aspect ratio is 16:9, the imaging device 1 is thicker when the aspect ratio is 4:3.

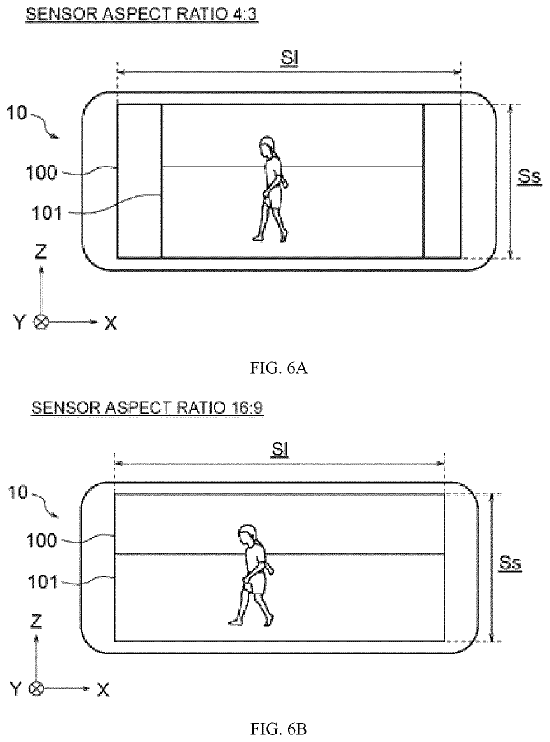

Further, FIG. 6A and FIG. 6B show an example of a captured image 101 which is displayed on a display screen 100 of a mobile phone 10 when the imaging lens assembly 21 is applied to the mobile phone 10. As shown in FIG. 6A and FIG. 6B, the difference between the aspect ratio of the image sensor 23 and the aspect ratio of the display screen 100 (size Sl in the longer direction:size Ss in the shorter direction) is larger when the aspect ratio of the image sensor 23 is 4:3 than when the aspect ratio of the image sensor 23 is 16:9. Accordingly, when the aspect ratio of the image sensor 23 is 4:3, since the size of the longer direction of the captured image 101 is too small compared to the size of the longer direction of the display screen 100, it is difficult to display the captured image 101 effectively utilizing the display screen 100.

If a value of DISV/DISD exceeds the upper limit of the inequality (4), since the image sensor 23 is too large in the shorter direction of the image sensor 23, it is difficult to make the imaging device 1 thin, as in the case where the aspect ratio is 4:3. Further, when the value of DISV/DISD exceeds the upper limit of inequality (4), as in the case where the aspect ratio is 4:3, it is difficult to display the captured image 101 while effectively utilizing the display screen 100.

Also, the imaging lens assembly 21 may more effectively increase the angle of view by satisfying the following inequality (5):

$$TTL / DISD < 2.5 . \qquad ( 5 )$$

In the inequality (5), TTL is a distance on the optical axis OA from a surface on the object side of a lens, which is disposed closest to an object among the lens group 33, to the imaging surface S (hereinafter the same applies).

If a value of TTL/DISD exceeds the upper limit of inequality (5), the entire length of the imaging lens assembly 21 and the focal length is too large, and thus it is difficult to increase the angle of view.

Further, the imaging lens assembly 21 may improve image quality by satisfying the following inequality (6):

$$DISD > 4 mm . \qquad ( 6 )$$

If a value of DISD falls below the lower limit of the inequality (6), since a substantial size of the image sensor 23 is small and a pixel pitch is also small, it is difficult to improve image quality.

Further, the imaging lens assembly 21 may improve image quality through the size of the image sensor 23 by satisfying the following inequality (7). The thickness of the image sensor 23 in Y direction increases when the size of the sensor 23 is large, but it is possible to reduce the thickness of the imaging device 1 according to the present disclosure.

$$EFL / da < 2. \qquad ( 7 )$$

In the inequality (7), EFL is a focal length of the imaging lens assembly 21 (hereinafter the same applies). EFL/da is an F number of the imaging lens assembly 21 (hereinafter the same applies).

If a value of EFL/da exceeds the upper limit of the inequality (7), since an image is too dark, it is difficult to improve image quality when shooting in dark places, such as shooting at night.

An aspherical lens among the lenses included in the imaging lens assembly 21 is formed of glass materials and plastic materials. However, from the viewpoint of lens molding, it is preferable that the aspherical lens is formed of a plastic material. This is because if the aspherical lens is made of a material other than a plastic, a tolerance with respect to an outer shape of the lens is large, and thus, lens eccentricity occurs and it is difficult to obtain a favorable quality image.

Such a camera module 11 including the imaging lens assembly 21 may be used in compact digital devices (imaging devices 1) such as mobile phones, wearable cameras and surveillance cameras.

### Configuration Examples of the Camera Module

Next, more specific examples to which the present disclosure is applied will be described. An example applying a prism 32 as the optical member 32 will be described below. In the following examples, “Si” indicates the ordinal number of the i-th surface which sequentially increases from the object side toward the imaging surface S side. Optical elements of the corresponding surfaces are indicated by the corresponding surface number “Si”. Denotations of “first surface” or “1ST surface” indicate a surface on the object side of the lens, and denotations of “second surface” or “2ND surface” indicate a surface on the imaging surface S side of the lens. “Ri” indicates the value of a central curvature radius (mm) of the surface. “Di” indicates a value of a distance on the optical axis between the i-th surface and the (i+1)-th surface (mm). “Ndi” indicates a value of a refractive index at d-line (wavelength 587.6 nm) of the material of the optical element having the i-th surface. “vdi” indicates a value of the Abbe number at d-line of the material of the optical element having the i-th surface. “EFLi” indicates the focal length of the i-th lens from the object side.

The imaging lens assembly 21 used in the following examples includes lenses having aspheric surfaces. The aspheric shape of the lens is defined by the following formula (8):

$$Z = C \times {h}^{2} / \{ 1 + {[ 1 - ( 1 + K ) \times \cdot {C}^{2} \times {h}^{2} ]}^{1 / 2} \} + \sum An \times {h}^{n} \qquad ( 8 )$$

(n=an integer greater than or equal to 3)

In the formula (8), Z is a depth of the aspheric surface, C is a paraxial curvature which is equal to 1/R, h is a distance from the optical axis to a lens surface, K is a conic constant (second-order aspheric coefficient), and An is an nth-order aspheric coefficient.

### FIRST EXAMPLE

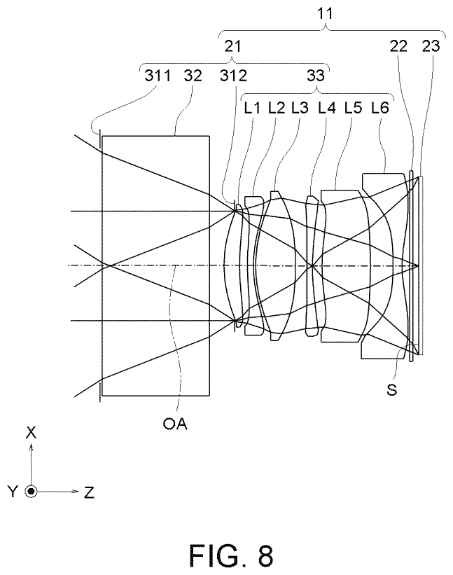

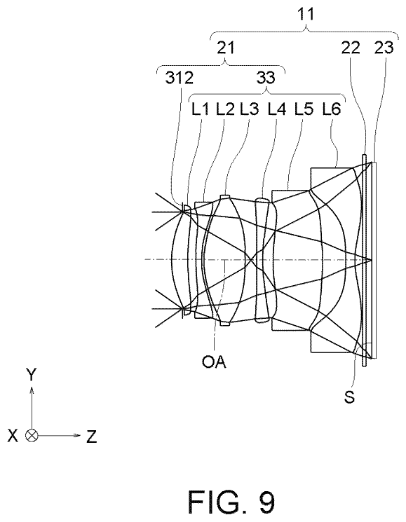

First, a first example in which specific numerical values are applied to the camera module 11 shown in FIGS. 7 to 9 will be described. FIG. 7 is a YZ cross-sectional view obtained by cutting the camera module 11 in a YZ cross-section including the optical axis OA. FIG. 8 is a XZ cross-sectional view obtained by cutting the camera module 11 in a XZ cross-section including the optical axis OA. Note that, in FIGS. 7 and 8, an optical path of rays passing through the imaging lens assembly 21 is drawn in a solid line. Also, FIGS. 7 and 8 express the optical axis within the prism 32 as a straight line, omitting the reflective surface 322 of the prism 32 for a convenience of description. The actual YZ cross-section of the prism 32 and the actual YZ cross-section of the light-shielding mask 311 is similar to that of FIG. 1. Also, the actual XZ cross-section of the prism 32 differs from that of FIG. 8. On the other hand, FIG. 7 shows the actual YZ cross-section of the lens group 33 and the actual height (i.e., dimension in Y-axis) of the prism 32. FIG. 8 shows the actual XZ cross-section of the lens group 33 and an actual width (i.e., dimension in X-axis) of the prism 32. FIG. 9 is a schematic diagram illustrating the optical path of the imaging lens assembly 21 in which the prism 32 is not disposed in the imaging lens assembly 21 according to the first example. As shown in FIG. 9, in the state where prism 32 is not disposed, in the imaging lens assembly 21, light is not shielded by optical elements other than the aperture stop 312. In the examples below, similar figures to that of FIGS. 7-9 will be disclosed, but redundant description will be omitted.

In the first example, the imaging lens assembly 21 includes, in order from the object side toward the image side, the prism 32, a first lens L1 having a positive refractive power in a paraxial region and a convex surface facing the object side, a second lens L2 having a negative refractive power in the paraxial region, a third lens L3 having the positive refractive power in the paraxial region and convex surfaces facing the object side and the image side, a fourth lens L4 having the negative refractive power in the paraxial region, a fifth lens L5 having the positive refractive power in the paraxial region and convex surfaces facing the object side and the image side, and a sixth lens L6 having the negative refractive power in the paraxial region and concave surfaces facing the image side and the object side. The light-shielding mask 311 is disposed on the incident surface of the prism 32. The aperture 312 is disposed between a vertex of the first surface of the first lens L1 and a second surface of the first lens L1.

Table 1 shows lens data of the first example. “INF” in Table 1 indicates an infinity (hereafter the same applies). A fourth optical surface (i=4) in Table 1 is a virtual optical surface set for convenience to express a distance between surfaces “Di” in a case where the vertex of the first surface of the first lens L1 penetrates the aperture stop 312 and is disposed closer to the object side compared to the aperture stop 312 as shown in FIG. 7 (hereinafter the same applies). Table 2 shows aspheric coefficients of the imaging lens assembly 21. In the aspheric coefficients, “E-i” indicates an exponential expression with a base of 10, i.e., “10⁻ⁱ”. For example, “−9.387334.E-04” indicates “−9.387334×10⁻⁴”. Table 3 shows values of parameters corresponding to the conditional expressions. In Table 3, dh is the size of the longer direction of the first aperture 311a of the light-shielding mask 311 (see FIG. 3). PH is the height (i.e., dimension in Y-axis) of the prism 32. RI is a relative illumination of the imaging lens assembly 21 in the state where the prism 32 is not disposed (state in FIG. 9). RIP is the relative illumination of the lens assembly 21 in the state where the prism 32 is disposed.

TABLE 1

| Si | Ri | Di | Ndi | ν d i | E F L i | E F L |
|---|---|---|---|---|---|---|
| 1 (LIGHT-SHIELDING MASK) | INF | 0 | | | | |
| 2 (INCIDENT SURFACE | INF | 7.1 | 1.517 | 64.167 | | |
| OF PRISM) | | | | | | |
| 3 (EMITTING SURFACE | INF | 1.000 | | | | |
| OF PRISM ) | | | | | | |
| 4 | INF | 0.700 | | | | |
| 5 (APERTURE STOP) | INF | −0.700 | | | | |
| 6 (1ST SURFACE OF L1) | 5.845 | 1.028 | 1.535 | 55.711 | 18.89 | 9.095 |
| 7 (2ND SURFACE OF L1) | 12.947 | 0.521 | | | | |
| 8 (1ST SURFACE OF L2) | 12.854 | 0.400 | 1.608 | 26.904 | −19.42 | |
| 9 (2ND SURFACE OF L2) | 6.102 | 0.157 | | | | |
| 10 (1ST SURFACE OF L3) | 6.450 | 2.672 | 1.535 | 55.711 | 8.80 | |
| 11 (2ND SURFACE OF L3) | −15.068 | 0.735 | | | | |
| 12 (1ST SURFACE OF L4) | 66.637 | 0.400 | 1.635 | 23.971 | −22.13 | |
| 13 (2ND SURFACE OF L4) | 11.648 | 0.642 | | | | |
| 14 (1ST SURFACE OF L5) | 9.421 | 3.208 | 1.567 | 37.556 | 10.90 | |
| 15 (2ND SURFACE OF L5) | −15.9914 | 1.528 | | | | |
| 16 (1ST SURFACE OF L6) | −19.0212 | 0.600 | 1.567 | 37.556 | −7.10 | |
| 17 (2ND SURFACE OF L6) | 5.1941 | 0.500 | | | | |
| 18 (1ST SURFACE OF | INF | 0.210 | 1.517 | 64.167 | | |
| OPTICAL FILTER) | | | | | | |
| 19 (2ND SURFACE OF | INF | 0.400 | | | | |
| OPTICAL FILTER) | | | | | | |
| 20 (IMAGE SURFACE) | INF | 0.000 | | | | |

TABLE 2

| | 6 (1ST | 7 (2ND | 8 (1ST | 9 (2ND |
|---|---|---|---|---|
| | SURFACE | SURFACE | SURFACE | SURFACE |
| Si | OF L1) | OF L1) | OF L2) | OF L2) |
| K | 0.217458 | −10.791694 | 0.541022 | −0.203916 |
| A3 | 0.000000.E+00 | 0.000000.E+00 | 0.000000.E+00 | 0.000000.E+00 |
| A4 | −9.387334.E−04 | 7.152678.E−04 | 2.255817.E−03 | 5.956173.E−03 |
| A5 | 0.000000.E+00 | 0.000000.E+00 | 0.000000.E+00 | 0.000000.E+00 |
| A6 | 4.649610.E−04 | −1.369554.E−03 | −3.561866.E−03 | −6.797966.E−03 |
| A7 | 0.000000.E+00 | 0.000000.E+00 | 0.000000.E+00 | 0.000000.E+00 |
| A8 | −6.349723.E−04 | 1.150494.E−03 | 1.555380.E−03 | 3.646050.E−03 |
| A9 | 0.000000.E+00 | 0.000000.E+00 | 0.000000.E+00 | 0.000000.E+00 |
| A10 | 4.343633.E−04 | −8.346844.E−04 | −6.022058.E−04 | −1.618672.E−03 |
| A11 | 0.000000.E+00 | 0.000000.E+00 | 0.000000.E+00 | 0.000000.E+00 |
| A12 | −1.760047.E−04 | 4.235323.E−04 | 2.199097.E−04 | 6.033324.E−04 |
| A13 | 0.000000.E+00 | 0.000000.E+00 | 0.000000.E+00 | 0.000000.E+00 |
| A14 | 3.891071.E−05 | −1.506585.E−04 | −7.224338.E−05 | −1.745427.E−04 |
| A15 | 0.000000.E+00 | 0.000000.E+00 | 0.000000.E+00 | 0.000000.E+00 |
| A16 | −1.791080.E−06 | 3.836413.E−05 | 1.974612.E−05 | 3.731562.E−05 |
| A17 | 0.000000.E+00 | 0.000000.E+00 | 0.000000.E+00 | 0.000000.E+00 |
| A18 | −1.594526.E−06 | −7.099906.E−06 | −4.262594.E−06 | −5.795754.E−06 |
| A19 | 0.000000.E+00 | 0.000000.E+00 | 0.000000.E+00 | 0.000000.E+00 |
| A20 | 5.362279.E−07 | 9.604617.E−07 | 7.009797.E−07 | 6.488123.E−07 |
| A21 | 0.000000.E+00 | 0.000000.E+00 | 0.000000.E+00 | 0.000000.E+00 |
| A22 | −8.976551.E−08 | −9.444071.E−08 | −8.485672.E−08 | −5.171003.E−08 |
| A23 | 0.000000.E+00 | 0.000000.E+00 | 0.000000.E+00 | 0.000000.E+00 |
| A24 | 9.164134.E−09 | 6.606560.E−09 | 7.253450.E−09 | 2.859841.E−09 |
| A25 | 0.000000.E+00 | 0.000000.E+00 | 0.000000.E+00 | 0.000000.E+00 |
| A26 | −5.774601.E−10 | −3.133627.E−10 | −4.116545.E−10 | −1.042851.E−10 |
| A27 | 0.000000.E+00 | 0.000000.E+00 | 0.000000.E+00 | 0.000000.E+00 |
| A28 | 2.073084.E−11 | 9.078742.E−12 | 1.386150.E−11 | 2.254726.E−12 |
| A29 | 0.000000.E+00 | 0.000000.E+00 | 0.000000.E+00 | 0.000000.E+00 |
| A30 | −3.254101.E−13 | −1.217039.E−13 | −2.090550.E−13 | −2.189534.E−14 |
| | 10 (1ST | 11 (2ND | 12 (1ST | 13 (2ND |
| | SURFACE | SURFACE | SURFACE | SURFACE |
| Si | OF L3) | OF L3) | OF L4) | OF L4) |
| K | −0.125153 | 1.569778 | −21.653948 | −11.830820 |
| A3 | 0.000000.E+00 | 0.000000.E+00 | 0.000000.E+00 | 0.000000.E+00 |
| A4 | 2.648874.E−03 | −1.385218.E−03 | 1.413446.E−03 | 1.535852.E−03 |
| A5 | 0.000000.E+00 | 0.000000.E+00 | 0.000000.E+00 | 0.000000.E+00 |
| A6 | −3.243706.E−03 | −1.234243.E−03 | −3.051121.E−03 | −1.851161.E−03 |
| A7 | 0.000000.E+00 | 0.000000.E+00 | 0.000000.E+00 | 0.000000.E+00 |
| A8 | 1.650469.E−03 | 8.650234.E−04 | 1.889575.E−03 | 8.103028.E−04 |
| A9 | 0.000000.E+00 | 0.000000.E+00 | 0.000000.E+00 | 0.000000.E+00 |
| A10 | −6.987884.E−04 | −4.608048.E−04 | −9.560170.E−04 | −3.261407.E−04 |
| A11 | 0.000000.E+00 | 0.000000.E+00 | 0.000000.E+00 | 0.000000.E+00 |
| A12 | 2.562710.E−04 | 1.737443.E−04 | 3.731658.E−04 | 1.204896.E−04 |
| A13 | 0.000000.E+00 | 0.000000.E+00 | 0.000000.E+00 | 0.000000.E+00 |
| A14 | −7.336093.E−05 | −4.625534.E−05 | −1.072810.E−04 | −3.538267.E−05 |
| A15 | 0.000000.E+00 | 0.000000.E+00 | 0.000000.E+00 | 0.000000.E+00 |
| A16 | 1.545140.E−05 | 8.863770.E−06 | 2.262071.E−05 | 7.781238.E−06 |
| A17 | 0.000000.E+00 | 0.000000.E+00 | 0.000000.E+00 | 0.000000.E+00 |
| A18 | −2.356457.E−06 | −1.238722.E−06 | −3.504085.E−06 | −1.258151.E−06 |
| A19 | 0.000000.E+00 | 0.000000.E+00 | 0.000000.E+00 | 0.000000.E+00 |
| A20 | 2.589277.E−07 | 1.265259.E−07 | 3.968121.E−07 | 1.477428.E−07 |
| A21 | 0.000000.E+00 | 0.000000.E+00 | 0.000000.E+00 | 0.000000.E+00 |
| A22 | −2.029221.E−08 | −9.343496.E−09 | −3.234471.E−08 | −1.238319.E−08 |
| A23 | 0.000000.E+00 | 0.000000.E+00 | 0.000000.E+00 | 0.000000.E+00 |
| A24 | 1.106838.E−09 | 4.851661.E−10 | 1.840769.E−09 | 7.195693.E−10 |
| A25 | 0.000000.E+00 | 0.000000.E+00 | 0.000000.E+00 | 0.000000.E+00 |
| A26 | −3.993971.E−11 | −1.677405.E−11 | −6.917910.E−11 | −2.751451.E−11 |
| A27 | 0.000000.E+00 | 0.000000.E+00 | 0.000000.E+00 | 0.000000.E+00 |
| A28 | 8.571847.E−13 | 3.459823.E−13 | 1.537986.E−12 | 6.233319.E−13 |
| A29 | 0.000000.E+00 | 0.000000.E+00 | 0.000000.E+00 | 0.000000.E+00 |
| A30 | −8.283292.E−15 | −3.214088.E−15 | −1.527614.E−14 | −6.357309.E−15 |
| | 14 (1ST | 15 (2ND | 16 (1ST | 17 (2ND |
| | SURFACE | SURFACE | SURFACE | SURFACE |
| Si | OF L5) | OF L5) | OF L6) | OF L6) |
| K | 4.922458 | −41.066992 | 3.069503 | −7.628771 |
| A3 | 0.000000.E+00 | 0.000000.E+00 | 0.000000.E+00 | 0.000000.E+00 |
| A4 | −2.424092.E−03 | 5.264070.E−03 | −1.201420.E−02 | −3.756019.E−03 |
| A5 | 0.000000.E+00 | 0.000000.E+00 | 0.000000.E+00 | 0.000000.E+00 |
| A6 | 2.945121.E−04 | −3.811829.E−03 | 5.459912.E−03 | 1.315691.E−04 |
| A7 | 0.000000.E+00 | 0.000000.E+00 | 0.000000.E+00 | 0.000000.E+00 |
| A8 | −1.827177.E−04 | 2.392908.E−03 | −3.710676.E−03 | −1.160090.E−06 |
| A9 | 0.000000.E+00 | 0.000000.E+00 | 0.000000.E+00 | 0.000000.E+00 |
| A10 | −1.497089.E−04 | −1.049212.E−03 | 1.635883.E−03 | −5.337074.E−08 |
| A11 | 0.000000.E+00 | 0.000000.E+00 | 0.000000.E+00 | 0.000000.E+00 |
| A12 | 1.900100.E−04 | 3.152926.E−04 | −4.851025.E−04 | −7.200166.E−09 |
| A13 | 0.000000.E+00 | 0.000000.E+00 | 0.000000.E+00 | 0.000000.E+00 |
| A14 | −9.717129.E−05 | −6.700106.E−05 | 1.004891.E−04 | 1.427101.E−09 |
| A15 | 0.000000.E+00 | 0.000000.E+00 | 0.000000.E+00 | 0.000000.E+00 |
| A16 | 3.009633.E−05 | 1.028447.E−05 | −1.486780.E−05 | −1.831684.E−10 |
| A17 | 0.000000.E+00 | 0.000000.E+00 | 0.000000.E+00 | 0.000000.E+00 |
| A18 | −6.234673.E−06 | −1.152212.E−06 | 1.588629.E−06 | 1.707390.E−11 |
| A19 | 0.000000.E+00 | 0.000000.E+00 | 0.000000.E+00 | 0.000000.E+00 |
| A20 | 8.944553.E−07 | 9.420083.E−08 | −1.226794.E−07 | −1.125183.E−12 |
| A21 | 0.000000.E+00 | 0.000000.E+00 | 0.000000.E+00 | 0.000000.E+00 |
| A22 | −8.937014.E−08 | −5.554013.E−09 | 6.771892.E−09 | 5.257171.E−14 |
| A23 | 0.000000.E+00 | 0.000000.E+00 | 0.000000.E+00 | 0.000000.E+00 |
| A24 | 6.110961.E−09 | 2.297467.E−10 | −2.601112.E−10 | −1.702640.E−15 |
| A25 | 0.000000.E+00 | 0.000000.E+00 | 0.000000.E+00 | 0.000000.E+00 |
| A26 | −2.727699.E−10 | −6.320618.E−12 | 6.593339.E−12 | 3.624397.E−17 |
| A27 | 0.000000.E+00 | 0.000000.E+00 | 0.000000.E+00 | 0.000000.E+00 |
| A28 | 7.160591.E−12 | 1.037614.E−13 | −9.900395.E−14 | −4.548389.E−19 |
| A29 | 0.000000.E+00 | 0.000000.E+00 | 0.000000.E+00 | 0.000000.E+00 |
| A30 | −8.381671.E−14 | −7.684246.E−16 | 6.661097.E−16 | 2.537861.E−21 |

TABLE 3

| | |
|---|---|
| DISD (mm) | 6.246 |
| DISV (mm) | 3.748 |
| DISV/DISD | 0.600 |
| TTL (mm) | 13.000 |
| TTL/DISD | 2.08 |
| DFOV (°) | 68.09 |
| tan(DFOV/2) | 0.676 |
| BL (mm) | 1.110 |
| EFL (mm) | 9.095 |
| da (mm) | 6.1 |
| EFL/da | 1.491 |
| dm (mm) | 6.15 |
| dh (mm) | 13.00 |
| PH (mm) | 7.1 |
| RI (%) | 53.4 |
| RIP (%) | 43 |

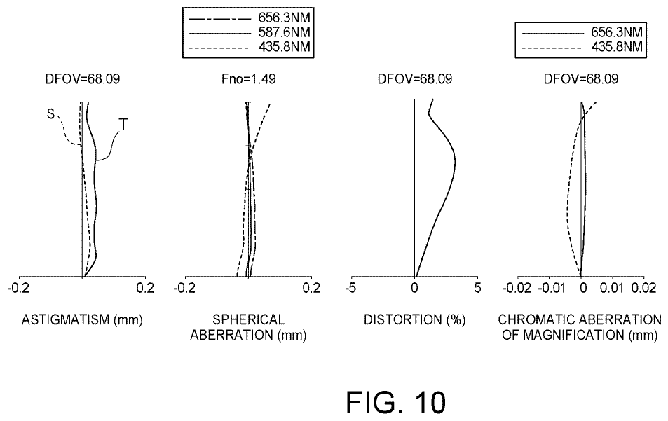

Aberrations in the first example are shown in FIG. 10. FIG. 10 shows, as examples of aberrations, spherical aberration, astigmatism (field curvature), distortion and chromatic aberration of magnification. In the graph showing astigmatism, a reference wavelength is d-line (587.6 nm). Further, “S” indicates a value of aberration on a sagittal image surface and “T” indicates a value of aberration on a tangential image surface. In the spherical aberration schematic diagram, aberrations with respect to C-line (656.3 nm), d-line and g-line (435.8 nm) are shown. In the distortion schematic diagram, a reference wavelength is d-line. In the chromatic aberration of a magnification schematic diagram, chromatic aberrations of magnification of C-line and g-line when d-line is used as a reference wavelength are shown. The same applies to aberration schematic diagrams in other examples.

As can be known from the aberration schematic diagrams in FIG. 10, the camera module 11 in the first example clearly has an excellent optical performance by favorably correcting the aberrations.

Further, it is known that only about slightly more than ten percent of the relative illumination may be obtained when the telephoto lenses are applied to the periscope type imaging lens assembly. On the other hand, according to the cameral module 11 in the first example, the relative illumination up to 43% may be obtained for the wide angle as shown in Table 3.

### SECOND EXAMPLE

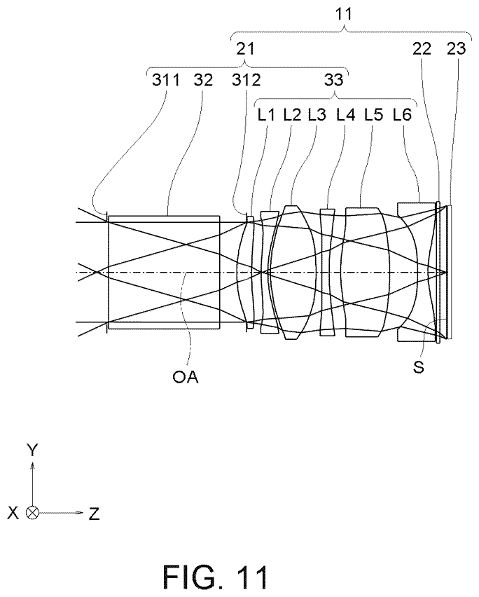

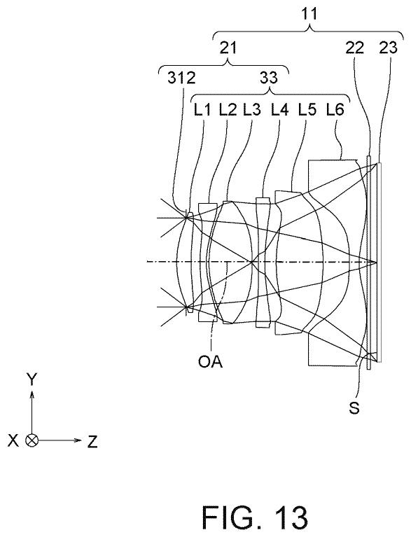

Next, a second example in which specific numerical values are applied to the camera module 11 shown in FIGS. 11 to 13 will be described.

The lens parameters corresponding to those in the first example are shown in Tables 4 to 6.

TABLE 4

| Si | Ri | Di | Ndi | ν d i | E F L i | E F L |
|---|---|---|---|---|---|---|
| 1 (LIGHT-SHIELDING MASK) | INF | 0 | | | | |
| 2 (INCIDENT SURFACE | INF | 6.6 | 1.517 | 64.167 | | |
| OF PRISM) | | | | | | |
| 3 (EMITTING SURFACE | INF | 1.000 | | | | |
| OF PRISM ) | | | | | | |
| 4 | INF | 0.600 | | | | |
| 5 (APERTURE STOP) | INF | −0.600 | | | | |
| 6 (1ST SURFACE OF L1) | 5.993 | 0.892 | 1.535 | 55.711 | 18.47 | 8.327 |
| 7 (2ND SURFACE OF L1) | 14.357 | 0.569 | | | | |
| 8 (1ST SURFACE OF L2) | 13.172 | 0.400 | 1.608 | 26.904 | −20.25 | |
| 9 (2ND SURFACE OF L2) | 6.311 | 0.164 | | | | |
| 10 (1ST SURFACE OF L3) | 6.913 | 2.690 | 1.535 | 55.711 | 8.61 | |
| 11 (2ND SURFACE OF L3) | −12.068 | 0.378 | | | | |
| 12 (1ST SURFACE OF L4) | 169.359 | 0.400 | 1.635 | 23.971 | −19.78 | |
| 13 (2ND SURFACE OF L4) | 11.764 | 0.714 | | | | |
| 14 (1ST SURFACE OF L5) | 9.077 | 2.924 | 1.567 | 37.556 | 8.96 | |
| 15 (2ND SURFACE OF L5) | −10.2967 | 1.657 | | | | |
| 16 (1ST SURFACE OF L6) | −16.0665 | 0.600 | 1.567 | 37.556 | −6.64 | |
| 17 (2ND SURFACE OF L6) | 5.0153 | 0.500 | | | | |
| 18 (1ST SURFACE OF | INF | 0.210 | 1.517 | 64.167 | | |
| OPTICAL FILTER) | | | | | | |
| 19 (2ND SURFACE OF | INF | 0.400 | | | | |
| OPTICAL FILTER) | | | | | | |
| 20 (IMAGE SURFACE) | INF | 0.000 | | | | |

TABLE 5

| | 6 (1ST | 7 (2ND | 8 (1ST | 9 (2ND |
|---|---|---|---|---|
| | SURFACE | SURFACE | SURFACE | SURFACE |
| Si | OF L1) | OF L1) | OF L2) | OF L2) |
| K | 0.082781 | −12.930418 | −3.992931 | −0.293554 |
| A3 | 0.000000.E+00 | 0.000000.E+00 | 0.000000.E+00 | 0.000000.E+00 |
| A4 | −3.403397.E−04 | 2.199174.E−03 | 7.184650.E−03 | 1.366896.E−02 |
| A5 | 0.000000.E+00 | 0.000000.E+00 | 0.000000.E+00 | 0.000000.E+00 |
| A6 | 2.027513.E−04 | −1.873213.E−03 | −6.084932.E−03 | −1.357372.E−02 |
| A7 | 0.000000.E+00 | 0.000000.E+00 | 0.000000.E+00 | 0.000000.E+00 |
| A8 | −5.890875.E−04 | 1.004846.E−03 | 4.801194.E−04 | 6.396847.E−03 |
| A9 | 0.000000.E+00 | 0.000000.E+00 | 0.000000.E+00 | 0.000000.E+00 |
| A10 | 5.377938.E−04 | −5.269484.E−04 | 1.842910.E−03 | −2.167772.E−03 |
| A11 | 0.000000.E+00 | 0.000000.E+00 | 0.000000.E+00 | 0.000000.E+00 |
| A12 | −3.075048.E−04 | 1.921205.E−04 | −1.675509.E−03 | 5.599040.E−04 |
| A13 | 0.000000.E+00 | 0.000000.E+00 | 0.000000.E+00 | 0.000000.E+00 |
| A14 | 1.192746.E−04 | −3.599153.E−05 | 8.354994.E−04 | −1.093662.E−04 |
| A15 | 0.000000.E+00 | 0.000000.E+00 | 0.000000.E+00 | 0.000000.E+00 |
| A16 | −3.210909.E−05 | −2.420073.E−06 | −2.785701.E−04 | 1.619597.E−05 |
| A17 | 0.000000.E+00 | 0.000000.E+00 | 0.000000.E+00 | 0.000000.E+00 |
| A18 | 5.941549.E−06 | 3.448019.E−06 | 6.544056.E−05 | −1.880927.E−06 |
| A19 | 0.000000.E+00 | 0.000000.E+00 | 0.000000.E+00 | 0.000000.E+00 |
| A20 | −7.184928.E−07 | −1.008926.E−06 | −1.099414.E−05 | 1.801691.E−07 |
| A21 | 0.000000.E+00 | 0.000000.E+00 | 0.000000.E+00 | 0.000000.E+00 |
| A22 | 4.810485.E−08 | 1.663197.E−07 | 1.314257.E−06 | −1.450135.E−08 |
| A23 | 0.000000.E+00 | 0.000000.E+00 | 0.000000.E+00 | 0.000000.E+00 |
| A24 | −3.062482.E−10 | −1.713220.E−08 | −1.091336.E−07 | 9.280451.E−10 |
| A25 | 0.000000.E+00 | 0.000000.E+00 | 0.000000.E+00 | 0.000000.E+00 |
| A26 | −2.243150.E−10 | 1.092877.E−09 | 5.978449.E−09 | −4.216251.E−11 |
| A27 | 0.000000.E+00 | 0.000000.E+00 | 0.000000.E+00 | 0.000000.E+00 |
| A28 | 1.663998.E−11 | −3.952795.E−11 | −1.940622.E−10 | 1.162396.E−12 |
| A29 | 0.000000.E+00 | 0.000000.E+00 | 0.000000.E+00 | 0.000000.E+00 |
| A30 | −4.042653.E−13 | 6.193861.E−13 | 2.823788.E−12 | −1.433191.E−14 |
| | 10 (1ST | 11 (2ND | 12 (1ST | 13 (2ND |
| | SURFACE | SURFACE | SURFACE | SURFACE |
| Si | OF L3) | OF L3) | OF L4) | OF L4) |
| K | −0.186740 | 3.401845 | 41.681331 | −10.846206 |
| A3 | 0.000000.E+00 | 0.000000.E+00 | 0.000000.E+00 | 0.000000.E+00 |
| A4 | 6.170009.E−03 | −5.919858.E−04 | 3.553177.E−03 | 4.332989.E−03 |
| A5 | 0.000000.E+00 | 0.000000.E+00 | 0.000000.E+00 | 0.000000.E+00 |
| A6 | −6.372140.E−03 | −2.060921.E−03 | −4.223661.E−03 | −4.620285.E−03 |
| A7 | 0.000000.E+00 | 0.000000.E+00 | 0.000000.E+00 | 0.000000.E+00 |
| A8 | 2.673970.E−03 | 1.053595.E−03 | 1.886753.E−03 | 2.863117.E−03 |
| A9 | 0.000000.E+00 | 0.000000.E+00 | 0.000000.E+00 | 0.000000.E+00 |
| A10 | −7.136966.E−04 | −5.020728.E−04 | −7.359178.E−04 | −1.444530.E−03 |
| A11 | 0.000000.E+00 | 0.000000.E+00 | 0.000000.E+00 | 0.000000.E+00 |
| A12 | 1.077201.E−04 | 1.866637.E−04 | 2.275827.E−04 | 5.480894.E−04 |
| A13 | 0.000000.E+00 | 0.000000.E+00 | 0.000000.E+00 | 0.000000.E+00 |
| A14 | 2.159011.E−06 | −4.851350.E−05 | −4.877997.E−05 | −1.515307.E−04 |
| A15 | 0.000000.E+00 | 0.000000.E+00 | 0.000000.E+00 | 0.000000.E+00 |
| A16 | −5.337419.E−06 | 8.753339.E−06 | 6.883160.E−06 | 3.073594.E−05 |
| A17 | 0.000000.E+00 | 0.000000.E+00 | 0.000000.E+00 | 0.000000.E+00 |
| A18 | 1.348225.E−06 | −1.107190.E−06 | −6.019806.E−07 | −4.614079.E−06 |
| A19 | 0.000000.E+00 | 0.000000.E+00 | 0.000000.E+00 | 0.000000.E+00 |
| A20 | −1.916790.E−07 | 9.844572.E−08 | 2.584989.E−08 | 5.121294.E−07 |
| A21 | 0.000000.E+00 | 0.000000.E+00 | 0.000000.E+00 | 0.000000.E+00 |
| A22 | 1.762231.E−08 | −6.090073.E−09 | 4.707114.E−10 | −4.145069.E−08 |
| A23 | 0.000000.E+00 | 0.000000.E+00 | 0.000000.E+00 | 0.000000.E+00 |
| A24 | −1.071465.E−09 | 2.547809.E−10 | −1.295307.E−10 | 2.374037.E−09 |
| A25 | 0.000000.E+00 | 0.000000.E+00 | 0.000000.E+00 | 0.000000.E+00 |
| A26 | 4.180160.E−11 | −6.805318.E−12 | 7.397697.E−12 | −9.098456.E−11 |
| A27 | 0.000000.E+00 | 0.000000.E+00 | 0.000000.E+00 | 0.000000.E+00 |
| A28 | −9.509700.E−13 | 1.032057.E−13 | −1.982067.E−13 | 2.089375.E−12 |
| A29 | 0.000000.E+00 | 0.000000.E+00 | 0.000000.E+00 | 0.000000.E+00 |
| A30 | 9.611499.E−15 | −6.596985.E−16 | 2.140415.E−15 | −2.170275.E−14 |
| | 14 (1ST | 15 (2ND | 16 (1ST | 17 (2ND |
| | SURFACE | SURFACE | SURFACE | SURFACE |
| Si | OF L5) | OF L5) | OF L6) | OF L6) |
| K | 4.458599 | −14.751048 | 6.164131 | −5.456672 |
| A3 | 0.000000.E+00 | 0.000000.E+00 | 0.000000.E+00 | 0.000000.E+00 |
| A4 | −8.315812.E−04 | 6.622597.E−03 | −1.649431.E−02 | −4.478884.E−03 |
| A5 | 0.000000.E+00 | 0.000000.E+00 | 0.000000.E+00 | 0.000000.E+00 |
| A6 | −1.403557.E−03 | −6.393022.E−03 | 8.087591.E−03 | 1.504045.E−04 |
| A7 | 0.000000.E+00 | 0.000000.E+00 | 0.000000.E+00 | 0.000000.E+00 |
| A8 | 1.204134.E−03 | 4.312949.E−03 | −4.994638.E−03 | −3.027401.E−07 |
| A9 | 0.000000.E+00 | 0.000000.E+00 | 0.000000.E+00 | 0.000000.E+00 |
| A10 | −8.542867.E−04 | −1.940472.E−03 | 2.003813.E−03 | −8.629226.E−08 |
| A11 | 0.000000.E+00 | 0.000000.E+00 | 0.000000.E+00 | 0.000000.E+00 |
| A12 | 4.302038.E−04 | 5.960543.E−04 | −5.503165.E−04 | −9.230394.E−09 |
| A13 | 0.000000.E+00 | 0.000000.E+00 | 0.000000.E+00 | 0.000000.E+00 |
| A14 | −1.530828.E−04 | −1.297619.E−04 | 1.073750.E−04 | 1.884447.E−09 |
| A15 | 0.000000.E+00 | 0.000000.E+00 | 0.000000.E+00 | 0.000000.E+00 |
| A16 | 3.874895.E−05 | 2.047139.E−05 | −1.518560.E−05 | −2.454540.E−10 |
| A17 | 0.000000.E+00 | 0.000000.E+00 | 0.000000.E+00 | 0.000000.E+00 |
| A18 | −7.024935.E−06 | −2.363940.E−06 | 1.572909.E−06 | 2.300885.E−11 |
| A19 | 0.000000.E+00 | 0.000000.E+00 | 0.000000.E+00 | 0.000000.E+00 |
| A20 | 9.124471.E−07 | 1.996334.E−07 | −1.194210.E−07 | −1.527176.E−12 |
| A21 | 0.000000.E+00 | 0.000000.E+00 | 0.000000.E+00 | 0.000000.E+00 |
| A22 | −8.406905.E−08 | −1.217660.E−08 | 6.572309.E−09 | 7.187506.E−14 |
| A23 | 0.000000.E+00 | 0.000000.E+00 | 0.000000.E+00 | 0.000000.E+00 |
| A24 | 5.357126.E−09 | 5.216634.E−10 | −2.550120.E−10 | −2.343339.E−15 |
| A25 | 0.000000.E+00 | 0.000000.E+00 | 0.000000.E+00 | 0.000000.E+00 |
| A26 | −2.242693.E−10 | −1.487655.E−11 | 6.605883.E−12 | 5.019210.E−17 |
| A27 | 0.000000.E+00 | 0.000000.E+00 | 0.000000.E+00 | 0.000000.E+00 |
| A28 | 5.544246.E−12 | 2.533513.E−13 | −1.023587.E−13 | −6.332520.E−19 |
| A29 | 0.000000.E+00 | 0.000000.E+00 | 0.000000.E+00 | 0.000000.E+00 |
| A30 | −6.128368.E−14 | −1.947956.E−15 | 7.162791.E−16 | 3.547834.E−21 |

TABLE 6

| | |
|---|---|
| DISD (mm) | 6.246 |
| DISV (mm) | 3.748 |
| DISV/DISD | 0.600 |
| TTL (mm) | 12.500 |
| TTL/DISD | 2.00 |
| DFOV (°) | 74.15 |
| tan(DFOV/2) | 0.756 |
| BL (mm) | 1.110 |
| EFL (mm) | 8.327 |
| da (mm) | 5.6 |
| EFL/da | 1.487 |
| dm (mm) | 5.60 |
| dh (mm) | 14.00 |
| PH (mm) | 6.6 |
| RI (%) | 37.7 |
| RIP (%) | 30.9 |

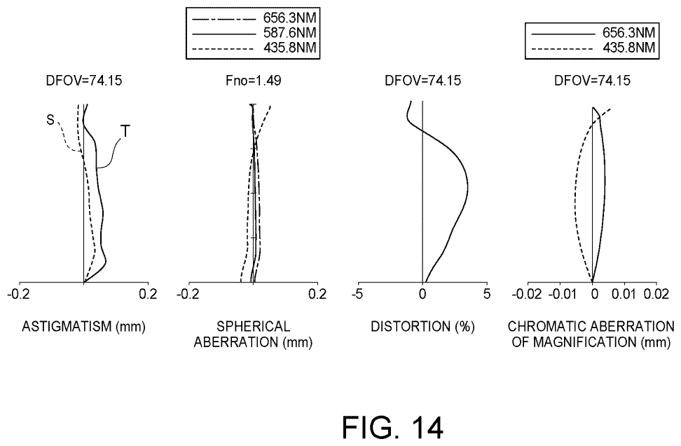

Aberrations in the second example are shown in FIG. 14. According to the second example, by making the lens parameters different from those of the first example, the degree of freedom in designing the camera module 11 according to the present disclosure can be further increased while obtaining the same effects as in the first example.

### THIRD EXAMPLE

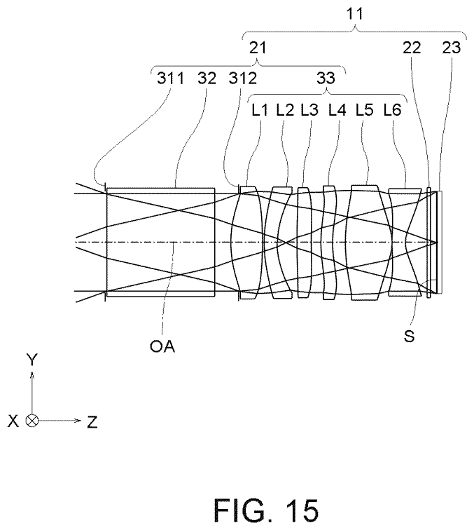

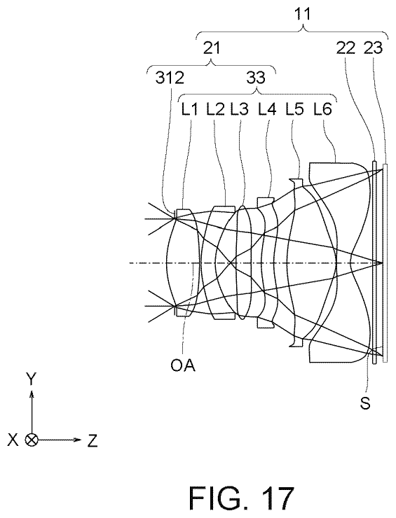

Next, a third example in which specific numerical values are applied to the camera module 11 shown in FIGS. 15 to 17 will be described.

The lens parameters corresponding to those in the first example are shown in Tables 7 to 9.

TABLE 7

| Si | Ri | Di | Ndi | ν d i | E F L i | E F L |
|---|---|---|---|---|---|---|
| 1 (LIGHT-SHIELDING MASK) | INF | 0 | | | | |
| 2 (INCIDENT SURFACE | INF | 6.8 | 1.517 | 64.167 | | |
| OF PRISM) | | | | | | |
| 3 (EMITTING SURFACE | INF | 1.000 | | | | |
| OF PRISM ) | | | | | | |
| 4 | INF | 0.500 | | | | |
| 5 (APERTURE STOP) | INF | −0.500 | | | | |
| 6 (1ST SURFACE OF L1) | 6.385 | 1.992 | 1.535 | 55.711 | 9.23 | 8.954 |
| 7 (2ND SURFACE OF L1) | −19.458 | 0.104 | | | | |
| 8 (1ST SURFACE OF L2) | 7.194 | 0.832 | 1.679 | 19.230 | −16.48 | |
| 9 (2ND SURFACE OF L2) | 4.155 | 1.227 | | | | |
| 10 (1ST SURFACE OF L3) | 32.632 | 0.901 | 1.535 | 55.711 | 103.89 | |
| 11 (2ND SURFACE OF L3) | 78.268 | 0.607 | | | | |
| 12 (1ST SURFACE OF L4) | 7.032 | 0.759 | 1.567 | 37.556 | −188.96 | |
| 13 (2ND SURFACE OF L4) | 6.341 | 0.785 | | | | |
| 14 (1ST SURFACE OF L5) | 10.084 | 2.952 | 1.535 | 55.711 | 3.59 | |
| 15 (2ND SURFACE OF L5) | −2.1326 | 0.010 | | | | |
| 16 (1ST SURFACE OF L6) | 9.0721 | 0.832 | 1.567 | 37.556 | −3.06 | |
| 17 (2ND SURFACE OF L6) | 1.4100 | 1.361 | | | | |
| 18 (1ST SURFACE OF | INF | 0.210 | 1.517 | 64.167 | | |
| OPTICAL FILTER) | | | | | | |
| 19 (2ND SURFACE OF | INF | 0.400 | | | | |
| OPTICAL FILTER) | | | | | | |
| 20 (IMAGE SURFACE) | INF | 0.000 | | | | |

TABLE 8

| | 6 (1ST | 7 (2ND | 8 (1ST | 9 (2ND |
|---|---|---|---|---|
| | SURFACE | SURFACE | SURFACE | SURFACE |
| Si | OF L1) | OF L1) | OF L2) | OF L2) |
| K | −0.729100 | −90.000000 | −5.507735 | −3.835430 |
| A3 | 0.000000.E+00 | 0.000000.E+00 | 0.000000.E+00 | 0.000000.E+00 |
| A4 | −1.718437.E−04 | −8.742112.E−04 | −1.603799.E−03 | 2.644847.E−04 |
| A5 | 0.000000.E+00 | 0.000000.E+00 | 0.000000.E+00 | 0.000000.E+00 |
| A6 | −5.947741.E−05 | −7.153679.E−05 | 1.472369.E−04 | 2.699574.E−04 |
| A7 | 0.000000.E+00 | 0.000000.E+00 | 0.000000.E+00 | 0.000000.E+00 |
| A8 | −4.272310.E−06 | −3.182451.E−06 | −1.397928.E−05 | −8.283821.E−05 |
| A9 | 0.000000.E+00 | 0.000000.E+00 | 0.000000.E+00 | 0.000000.E+00 |
| A10 | −2.710314.E−09 | −3.117802.E−07 | 1.472357.E−06 | 1.651740.E−05 |
| A11 | 0.000000.E+00 | 0.000000.E+00 | 0.000000.E+00 | 0.000000.E+00 |
| A12 | −2.568989.E−08 | 3.909591.E−08 | −1.105611.E−07 | −1.853416.E−06 |
| A13 | 0.000000.E+00 | 0.000000.E+00 | 0.000000.E+00 | 0.000000.E+00 |
| A14 | −5.164151.E−10 | −1.883145.E−09 | 8.637650.E−09 | 1.129284.E−07 |
| A15 | 0.000000.E+00 | 0.000000.E+00 | 0.000000.E+00 | 0.000000.E+00 |
| A16 | 0.000000.E+00 | 0.000000.E+00 | −2.961930.E−10 | −2.745398.E−09 |
| A17 | 0.000000.E+00 | 0.000000.E+00 | 0.000000.E+00 | 0.000000.E+00 |
| A18 | 0.000000.E+00 | 0.000000.E+00 | 0.000000.E+00 | 0.000000.E+00 |
| A19 | 0.000000.E+00 | 0.000000.E+00 | 0.000000.E+00 | 0.000000.E+00 |
| A20 | 0.000000.E+00 | 0.000000.E+00 | 0.000000.E+00 | 0.000000.E+00 |
| A21 | 0.000000.E+00 | 0.000000.E+00 | 0.000000.E+00 | 0.000000.E+00 |
| A22 | 0.000000.E+00 | 0.000000.E+00 | 0.000000.E+00 | 0.000000.E+00 |
| A23 | 0.000000.E+00 | 0.000000.E+00 | 0.000000.E+00 | 0.000000.E+00 |
| A24 | 0.000000.E+00 | 0.000000.E+00 | 0.000000.E+00 | 0.000000.E+00 |
| A25 | 0.000000.E+00 | 0.000000.E+00 | 0.000000.E+00 | 0.000000.E+00 |
| A26 | 0.000000.E+00 | 0.000000.E+00 | 0.000000.E+00 | 0.000000.E+00 |
| A27 | 0.000000.E+00 | 0.000000.E+00 | 0.000000.E+00 | 0.000000.E+00 |
| A28 | 0.000000.E+00 | 0.000000.E+00 | 0.000000.E+00 | 0.000000.E+00 |
| A29 | 0.000000.E+00 | 0.000000.E+00 | 0.000000.E+00 | 0.000000.E+00 |
| A30 | 0.000000.E+00 | 0.000000.E+00 | 0.000000.E+00 | 0.000000.E+00 |
| | 10 (1ST | 11 (2ND | 12 (1ST | 13 (2ND |
| | SURFACE | SURFACE | SURFACE | SURFACE |
| Si | OF L3) | OF L3) | OF L4) | OF L4) |
| K | 29.963652 | −74.368664 | −10.217967 | −11.652770 |
| A3 | 0.000000.E+00 | 0.000000.E+00 | 8.334317.E−04 | 3.213033.E−03 |
| A4 | 2.064085.E−05 | −1.360275.E−04 | −3.323203.E−03 | −6.141193.E−03 |
| A5 | 0.000000.E+00 | 0.000000.E+00 | −5.616523.E−04 | 9.712835.E−04 |
| A6 | −4.142399.E−05 | −3.633099.E−04 | 3.259950.E−04 | −2.330143.E−04 |
| A7 | 0.000000.E+00 | 0.000000.E+00 | −1.630357.E−05 | 5.264027.E−05 |
| A8 | −6.477724.E−05 | 3.966598.E−05 | −1.964478.E−05 | −1.399428.E−05 |
| A9 | 0.000000.E+00 | 0.000000.E+00 | −2.088267.E−06 | 2.069451.E−08 |
| A10 | 1.486047.E−05 | −5.992397.E−06 | 2.071988.E−07 | 1.319733.E−08 |
| A11 | 0.000000.E+00 | 0.000000.E+00 | 1.051864.E−07 | 3.695973.E−09 |
| A12 | −1.637198.E−06 | 5.443362.E−07 | −4.894143.E−09 | 7.000763.E−09 |
| A13 | 0.000000.E+00 | 0.000000.E+00 | −1.741108.E−09 | 1.669953.E−10 |
| A14 | 9.783557.E−08 | −2.387253.E−08 | −2.468273.E−10 | 3.626389.E−10 |
| A15 | 0.000000.E+00 | 0.000000.E+00 | −1.982535.E−10 | 5.500901.E−11 |
| A16 | −2.235687.E−09 | 4.184086.E−10 | −1.136445.E−11 | 6.479237.E−12 |
| A17 | 0.000000.E+00 | 0.000000.E+00 | 1.084576.E−11 | 3.987515.E−12 |
| A18 | 0.000000.E+00 | 0.000000.E+00 | 2.992999.E−12 | 7.851685.E−13 |
| A19 | 0.000000.E+00 | 0.000000.E+00 | 7.289493.E−13 | 1.715612.E−13 |
| A20 | 0.000000.E+00 | 0.000000.E+00 | 2.319318.E−14 | 1.757483.E−14 |
| A21 | 0.000000.E+00 | 0.000000.E+00 | 0.000000.E+00 | 0.000000.E+00 |
| A22 | 0.000000.E+00 | 0.000000.E+00 | 0.000000.E+00 | 0.000000.E+00 |
| A23 | 0.000000.E+00 | 0.000000.E+00 | 0.000000.E+00 | 0.000000.E+00 |
| A24 | 0.000000.E+00 | 0.000000.E+00 | 0.000000.E+00 | 0.000000.E+00 |
| A25 | 0.000000.E+00 | 0.000000.E+00 | 0.000000.E+00 | 0.000000.E+00 |
| A26 | 0.000000.E+00 | 0.000000.E+00 | 0.000000.E+00 | 0.000000.E+00 |
| A27 | 0.000000.E+00 | 0.000000.E+00 | 0.000000.E+00 | 0.000000.E+00 |
| A28 | 0.000000.E+00 | 0.000000.E+00 | 0.000000.E+00 | 0.000000.E+00 |
| A29 | 0.000000.E+00 | 0.000000.E+00 | 0.000000.E+00 | 0.000000.E+00 |
| A30 | 0.000000.E+00 | 0.000000.E+00 | 0.000000.E+00 | 0.000000.E+00 |
| | 14 (1ST | 15 (2ND | 16 (1ST | 17 (2ND |
| | SURFACE | SURFACE | SURFACE | SURFACE |
| Si | OF L5) | OF L5) | OF L6) | OF L6) |
| K | −32.665897 | −8.460711 | −90.000000 | −4.850213 |
| A3 | 3.858854.E−03 | 3.864196.E−03 | −4.646730.E−03 | −6.739250.E−03 |
| A4 | 1.898890.E−03 | −1.540717.E−03 | −8.563278.E−03 | −3.157808.E−03 |
| A5 | −6.098898.E−04 | 3.428305.E−04 | 1.118948.E−03 | 7.822620.E−04 |
| A6 | −7.579758.E−05 | 2.193897.E−05 | 9.169061.E−05 | 4.231063.E−05 |
| A7 | 1.320348.E−05 | −1.161868.E−06 | 2.258085.E−07 | −2.105651.E−05 |
| A8 | 1.033980.E−06 | −1.382420.E−06 | −1.527155.E−06 | 6.351813.E−07 |
| A9 | −2.520630.E−07 | −4.433326.E−07 | −5.670768.E−08 | −8.177420.E−09 |
| A10 | −1.525433.E−08 | −4.888915.E−08 | −3.175540.E−09 | 3.576128.E−09 |
| A11 | 1.374094.E−09 | 1.033684.E−09 | −2.360106.E−09 | 4.076167.E−10 |
| A12 | −2.448458.E−09 | 9.121933.E−10 | −2.313308.E−10 | −4.799142.E−11 |
| A13 | 3.644571.E−10 | 2.421753.E−10 | 6.688007.E−13 | 1.129444.E−11 |
| A14 | −4.829529.E−11 | 2.699417.E−11 | 1.369124.E−12 | 3.265840.E−12 |
| A15 | 1.630320.E−11 | −5.349620.E−13 | 6.210162.E−13 | 5.549577.E−13 |
| A16 | 3.251653.E−12 | −6.005668.E−13 | 1.253135.E−13 | 7.767083.E−14 |
| A17 | 5.523208.E−13 | −1.332110.E−13 | 1.947922.E−14 | 6.305487.E−15 |
| A18 | 4.326496.E−14 | −1.114337.E−14 | 2.400521.E−15 | 7.740343.E−16 |
| A19 | −2.864273.E−15 | 5.020834.E−16 | 3.931650.E−16 | −2.481192.E−16 |
| A20 | −7.432679.E−15 | 2.019548.E−15 | 1.029499.E−16 | −1.246587.E−16 |
| A21 | 0.000000.E+00 | 0.000000.E+00 | 0.000000.E+00 | 0.000000.E+00 |
| A22 | 0.000000.E+00 | 0.000000.E+00 | 0.000000.E+00 | 0.000000.E+00 |
| A23 | 0.000000.E+00 | 0.000000.E+00 | 0.000000.E+00 | 0.000000.E+00 |
| A24 | 0.000000.E+00 | 0.000000.E+00 | 0.000000.E+00 | 0.000000.E+00 |
| A25 | 0.000000.E+00 | 0.000000.E+00 | 0.000000.E+00 | 0.000000.E+00 |
| A26 | 0.000000.E+00 | 0.000000.E+00 | 0.000000.E+00 | 0.000000.E+00 |
| A27 | 0.000000.E+00 | 0.000000.E+00 | 0.000000.E+00 | 0.000000.E+00 |
| A28 | 0.000000.E+00 | 0.000000.E+00 | 0.000000.E+00 | 0.000000.E+00 |
| A29 | 0.000000.E+00 | 0.000000.E+00 | 0.000000.E+00 | 0.000000.E+00 |
| A30 | 0.000000.E+00 | 0.000000.E+00 | 0.000000.E+00 | 0.000000.E+00 |

TABLE 9

| | |
|---|---|
| DISD (mm) | 6.246 |
| DISV (mm) | 3.062 |
| DISV/DISD | 0.490 |
| TTL (mm) | 12.971 |
| TTL/DISD | 2.08 |
| DFOV (°) | 68.23 |
| tan(DFOV/2) | 0.677 |
| BL (mm) | 1.971 |
| EFL (mm) | 8.954 |
| da (mm) | 5.8 |
| EFL/da | 1.544 |
| dm (mm) | 5.80 |
| dh (mm) | 13.60 |
| PH (mm) | 6.8 |
| RI (%) | 42.6 |
| RIP (%) | 41.2 |

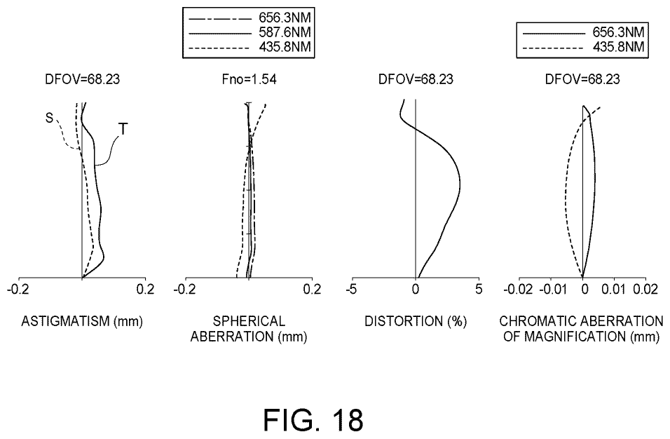

Aberrations in the third example are shown in FIG. 18. According to the third example, by making the lens parameters different from those of the first and second examples, the degree of freedom in designing the camera module 11 according to the present disclosure can be further increased while obtaining the same effects as in the first example.

In the description of embodiments of the present disclosure, it is to be understood that terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” should be construed to refer to the orientation or the position as described or as shown in the drawings under discussion. These relative terms are only used to simplify description of the present disclosure, and do not indicate or imply that the device or element referred to must have a particular orientation, or constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, “a plurality of” means two or more than two, unless specified otherwise.

In the description of embodiments of the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Reference throughout this specification to “an embodiment”, “some embodiments”, “an exemplary embodiment”, “an example”, “a specific example” or “some examples” means that a particular feature, structure, material, or characteristic described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

1. An imaging lens assembly, comprising:
an optical member, configured to bend an incident light incident from an object side toward an image side;
a lens group, disposed on the image side of the optical member and configured to image the incident light bent by the optical member on an imaging surface; and
a light-shielding member, configured for partially shielding the incident light, wherein the light-shielding member comprises:
a light-shielding mask, partially shielding the incident light on the object side of the optical member and being provided with a first aperture partially transmitting the incident light; and
an aperture stop, partially shielding the incident light on the image side of the optical member and being provided with a second aperture partially transmitting the incident light;
wherein the imaging lens assembly is configured such that:
$$tan ( DFOV / 2 ) > 0.59 ,$$
$$d m \geq da ,$$
wherein DFOV is a diagonal angle of view of the imaging lens assembly, dm is a size of the first aperture of the light-shielding mask in a first direction optically corresponding to a shorter direction of the imaging surface, and da is a size of the second aperture of the aperture stop in a second direction optically corresponding to the shorter direction of the imaging surface.

2. The imaging lens assembly according to claim 1, configured such that:
BL<4 mm,
wherein BL is a distance on an optical axis from a surface on the image side of a lens, which is disposed closest to an image among the lens group, to the imaging surface.

3. The imaging lens assembly according to claim 1, configured such that:
$$DISV / DISD < 0.61 .$$
wherein DISD is half a size of the imaging surface in a diagonal direction, and DISV is half a size of the imaging surface in the shorter direction.

4. The imaging lens assembly according to claim 1, configured such that:
$$TTL / DISD < 2.5 ,$$
wherein TTL is a distance on an optical axis from a surface on the object side of a lens, which is disposed closest to an object among the lens group, to the imaging surface, and DISD is half a size of the imaging surface in a diagonal direction.

5. The imaging lens assembly according to claim 1, configured such that:
DISD>4 mm,
wherein DISD is half a size of the imaging surface in a diagonal direction.

6. The imaging lens assembly according to claim 1, configured such that:
EFL/da<2,
wherein EFL is a focal length of the imaging lens assembly.

7. The imaging lens assembly according to claim 1, wherein a lens disposed closest to an image among the lens group has a negative refractive power and a plurality of inflection points.

8. The imaging lens assembly according to claim 1, wherein the light-shielding member is composed only of the light-shielding mask and the aperture stop.

9. The imaging lens assembly according to claim 1, wherein the optical member is configured to bend an optical axis of the imaging lens assembly by substantially 90° from the object side toward the image side.

10. The imaging lens assembly according to claim 9, wherein the optical axis of the imaging lens assembly has a first optical axis on the object side and a second optical axis on the image side, the second optical axis is connected to the first optical axis at a connection point on the optical member, so that the second optical axis is substantially perpendicular to the first optical axis,
the first optical axis is substantially parallel to the shorter direction of the imaging surface, and
the second optical axis is a common optical axis with an optical axis of the lens group.

11. The imaging lens assembly according to claim 9, wherein the first aperture of the light-shielding mask has a longer direction substantially parallel to a longer direction of the imaging surface and has a shorter direction substantially perpendicular to the shorter direction of the imaging surface.

12. The imaging lens assembly according to claim 11, wherein the size dm of the first aperture of the light-shielding mask in the first direction optically corresponding to the shorter direction of the imaging surface is a size of the first aperture in a shorter direction, and
the size da of the second aperture of the aperture stop in the second direction optically corresponding to the shorter direction of the imaging surface is a size of the second aperture in a direction parallel to the shorter direction of the imaging surface.

13. The imaging lens assembly according to claim 1, wherein the optical member has an incident surface on which the incident light is incident from the object side, a reflective surface which reflects the incident light incident from the incident surface toward the image side, and an emitting surface which emits the incident light reflected from the reflective surface toward the image side.

14. The imaging lens assembly according to claim 13, wherein the emitting surface is substantially perpendicular to the incident surface and is substantially parallel to the imaging surface; and/or
the light-shielding mask is disposed on the incident surface; and/or
the optical member is a prism.

15. The imaging lens assembly according to claim 1, wherein the lens group has four or more and seven or less lenses; and/or
the lens group is held in a single barrel.

16. The imaging lens assembly according to claim 1, wherein the aperture stop is disposed on the object side of a surface on the image side of a lens disposed closest to an object among the lens group.

17. The imaging lens assembly according to claim 1, wherein the lens group comprising, in order from the object side:
a first lens having a positive refractive power;
a second lens having a negative refractive power;
a third lens having the positive refractive power;
a fourth lens having the negative refractive power;
a fifth lens having the positive refractive power; and
a sixth lens having the negative refractive power.

18. A camera module, comprising:
an image sensor, comprising an imaging surface; and
an imaging lens assembly, comprising:
an optical member, configured to bend an incident light incident from an object side toward an image side;
a lens group, disposed on the image side of the optical member and configured to image the incident light bent by the optical member on the imaging surface; and
a light-shielding member, configured for partially shielding the incident light, wherein the light-shielding member comprises:
a light-shielding mask, partially shielding the incident light on the object side of the optical member and being provided with a first aperture partially transmitting the incident light; and
an aperture stop, partially shielding the incident light on the image side of the optical member and being provided with a second aperture partially transmitting the incident light;
wherein the imaging lens assembly is configured such that:
$$tan ( DFOV / 2 ) > 0.59 ,$$
$$d m \geq da ,$$
wherein DFOV is a diagonal angle of view of the imaging lens assembly, dm is a size of the first aperture of the light-shielding mask in a first direction optically corresponding to a shorter direction of the imaging surface, and da is a size of the second aperture of the aperture stop in a second direction optically corresponding to the shorter direction of the imaging surface.

19. The camera module according to claim 18, further comprising an optical filter disposed between the imaging lens assembly and the image sensor.

20. An imaging device, comprising:
a drive mechanism, integrally driving a lens group along an optical axis; and
a camera module, comprising:
an image sensor, comprising an imaging surface; and
an imaging lens assembly, comprising:
an optical member, configured to bend an incident light incident from an object side toward an image side;
the lens group, disposed on the image side of the optical member and configured to image the incident light bent by the optical member on the imaging surface; and
a light-shielding member, configured for partially shielding the incident light, wherein the light-shielding member comprises:
a light-shielding mask, partially shielding the incident light on the object side of the optical member and being provided with a first aperture partially transmitting the incident light; and
an aperture stop, partially shielding the incident light on the image side of the optical member and being provided with a second aperture partially transmitting the incident light;
wherein the imaging lens assembly is configured such that:
$$tan ( DFOV / 2 ) > 0.59 ,$$
$$d m \geq da ,$$
wherein DFOV is a diagonal angle of view of the imaging lens assembly, dm is a size of the first aperture of the light-shielding mask in a first direction optically corresponding to a shorter direction of the imaging surface, and da is a size of the second aperture of the aperture stop in a second direction optically corresponding to the shorter direction of the imaging surface.
